(19) United States
(12) Patent Application Publication
(10) Pub. No.: US 2009/0176423 A1
(43) Pub. Date: Jul. 9, 2009

(54) Fiber-treating liquid, modified cloth, and process for producing the same

(76) Inventors: Masahiro Sano, Tokyo (JP); Masashi Sakamoto, Chiba (JP); Shuichi Murakami, Ishikawa (JP); Ryousei Takigaura, Ishikawa (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 10/585,212

(22) PCT Filed: Jan. 6, 2005
(86) PCT No.: PCT/JP05/00087

§ 371 Date: Jul. 3, 2006

(30) Foreign Application Priority Data
Jan. 7, 2004 (JP) 2004-002484

(51) Int. Cl. B32B 5/02; B05D 3/02; C08L 89/00

(52) U.S. Cl. 442/59; 427/389.9; 524/21

(57) ABSTRACT

A modified fiber fabric obtainable by polymerizing a component (X) which is a water-soluble eggshell membrane powder, a component (A) which is a bifunctional monomer represented by the following formula (1), a component (B) which is a monomer containing any one of a hydroxyl group, carboxyl group, amino group, sulfonic acid group, and phosphoric acid group, and a component (C) which is a monomer containing at least one aziridine group, or a water-soluble polymer containing a polycarbodiimide group, polyethyleneimine group, or oxazoline group, on a fiber fabric,

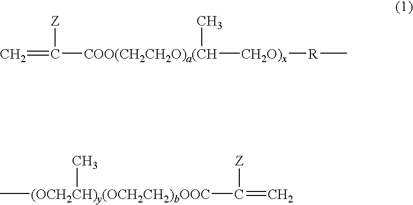

wherein R represents any one of

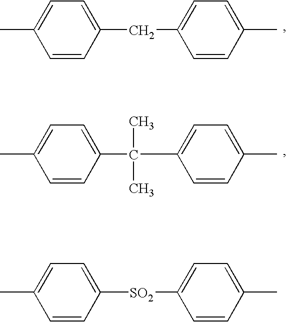

and —CₙH₂ₙ— (n is an integer of 1 to 6); Z is a hydrogen atom or a methyl group; a and b are integers where “a+b” is 0 to 50; x and y are integers where “x+y” is 0 to 30; and “a+b+x+y” is 10 or more.

### TECHNICAL FIELD

The invention relates to a modified fiber fabric which is suitably used for applications in which the modified fiber fabric directly contacts the skin, and a method for producing the same. More particularly, the invention relates to a low-irritant modified fiber fabric which ensures texture such as flexibility and drape properties, exhibits excellent water absorbing properties and hygroscopicity, exhibits excellent sweat absorbing properties or the like, exhibits durability, provides flexibility and elasticity to the skin, and exhibits a high skin regeneration support effect, and a method for producing the same.

### BACKGROUND ART

As a means for providing a fiber fabric with a long-lasting water absorbing treatment, a technology has been disclosed in which various monomers (e.g. vinyl monomer) are polymerized on the fiber fabric (see JP-A-58-169569, JP-A-8-48735, and JP-A-8-209540, for example).

A technology has also been disclosed in which a crosslinked vinyl sulfonic acid polymer and a modified organosilicate or the like are polymerized on a fiber fabric to provide the fiber fabric with a long-lasting water absorbing treatment and a stain-proof (prevention of blackening) treatment (see JP-A-11-61647, for example).

The above treatment aims at providing the fiber fabric with water absorbing properties and hygroscopicity mainly by polymerizing acrylic monomers on the fiber fabric. However, the above treatment cannot provide the fiber fabric with significant water absorbing properties and hygroscopicity. Moreover, a skin regeneration support effect cannot be provided at all.

A technology of polymerizing acrylic monomers on a fiber fabric together with intended substances having various properties to provide the properties of the substances to the fiber fabric has also been disclosed. JP-A-6-158545 discloses a technology of polymerizing acrylic monomers on the fiber fabric together with a silk fibroin aqueous solution as the intended substance to provide remarkable long-lasting water absorbing properties and hygroscopicity while ensuring silk-like texture such as flexibility and drape properties.

JP-A-7-300770 discloses a technology of polymerizing acrylic monomers on a fiber fabric together with an aqueous solution or liquid dispersion of collagen and an antimicrobial agent (e.g. quaternary ammonium salt type surfactant or chitosan) as the intended substances to provide the fiber fabric with long-lasting antimicrobial properties and remarkable water absorbing properties and hygroscopicity.

JP-A-2002-38375 discloses a technology of polymerizing acrylic monomers on a fiber fabric together with fine particles of an acrylic polymer having a salt-type carboxyl group and a crosslinked structure as the intended substance to provide the fiber fabric with remarkable long-lasting hygroscopic sorption properties.

These technologies provide the fiber fabric with remarkable long-lasting water absorbing properties and hygroscopicity. However, the amount of an intended substance adhering to the fiber fabric is less than 5 mass % of the weight of the fiber fabric. If the concentration (amount) of the intended substance is increased so that the amount adhered is increased, in order to improve the water absorbing properties and hygroscopicity, the fiber fabric shows a starched state which impairs texture such as flexibility and drape properties. Therefore, even if the intended substance is a skin-friendly natural substance containing protein/amino acid components, such as a protein obtained by pulverizing a bull leather or sericin extracted from a cocoon, it is difficult to increase the amount of target substance adhering to the fiber fabric to provide durability. As a result, it is impossible to provide the skin with flexibility and elasticity and exert a skin regeneration support effect.

An object of the invention is to provide a low-irritant modified fiber fabric which ensures texture such as flexibility and drape properties, exhibits excellent water absorbing properties and hygroscopicity, exhibits excellent sweat absorbing properties or the like, exhibits excellent durability (anti-washing properties), provides flexibility and elasticity to the skin, and exhibits a high skin regeneration support effect, and a method for producing the same.

### DISCLOSURE OF THE INVENTION

The inventors of the invention have conducted extensive studies in order to achieve the above object. As a result, the inventors found that use of a water-soluble eggshell membrane powder containing a specific protein-containing monomer and/or a polymer of an amino-acid-containing monomer with a fiber treating liquid and an optimum structure and configuration for polymerization on a fiber fabric can introduce the protein-containing monomer and/or the polymer of an amino-acid-containing monomer into the surface and inside of the fiber, provide flexibility and elasticity to the skin, and significantly improve the amount (polymerization rate) of amino acids adhering, which exhibit a skin regeneration support effect, adhering to the fiber fabric. This finding has led to the completion of the invention.

A modified fiber fabric according to the invention is obtained by polymerizing a component (X) which is a water-soluble eggshell membrane powder, a component (A) which is a bifunctional monomer represented by the following formula (1), a component (B) which is a monomer containing any one of a hydroxyl group, carboxyl group, amino group, sulfonic acid group, and phosphoric acid group, and a component (C) which is a monomer containing at least one aziridine group, or a water-soluble polymer containing a polycarbodiimide group, polyethyleneimine group, or oxazoline group, on a fiber fabric,

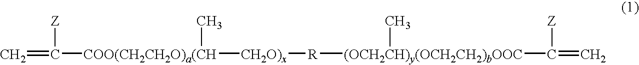

wherein R represents any one of

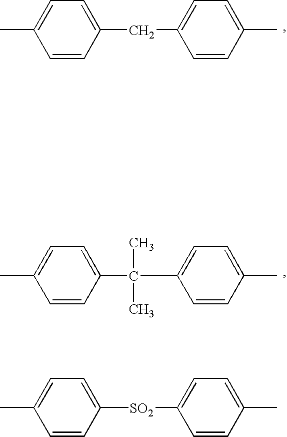

and —CₙH₂ₙ— (n is an integer of 1 to 6); Z is a hydrogen atom or a methyl group; a and b are integers where “a+b” is 0 to 50; x and y are integers where “x+y” is 0 to 30; and “a+b+x+y” is 10 or more.

According to the invention, a modified fiber fabric can be provided in which the component (X) and the components (A) to (C) are introduced into the surface and inside of the fiber. According to the invention, a modified fiber fabric can also be provided in which the component (X) and the components (A) to (C) are graft-polymerized to the fiber fabric. Note that the modified fiber fabric in which the component (X) is introduced into the surface and inside of the fiber or the modified fiber fabric in which the component (X) is graft-polymerized to the fiber fabric has not yet been disclosed. These modified fiber fabrics are also included in the invention.

The fiber treating liquid according to the invention comprises the component (X) and the components (A) to (C).

The first method for producing a modified fiber fabric according to the invention comprises a liquid-contacting step of bringing the fiber treating liquid according to the invention into contact with a fiber fabric, and a polymerization step of polymerizing the component (X) and the components (A) to (C) on the fiber fabric.

The second method for producing a modified fiber fabric according to the invention comprises a first liquid-contacting step of bringing a fiber treating liquid including the components (A) to (C) into contact with a fiber fabric, a first polymerization step of polymerizing the components (A) to (C) on the fiber fabric, a second liquid-contacting step of bringing a solution of the component (X) into contact with the fiber fabric on which the components (A) to (C) are polymerized, and a second polymerization step of polymerizing the component (X) on the fiber fabric.

According to these production methods, the modified fiber fabric according to the invention can be provided in which the component (X) and the components (A) to (C) are polymerized. In the first production method, the component (X) and the components (A) to (C) are polymerized at the same time. In the second production method, the components (A) to (C) are polymerized first, and the component (X) is then polymerized.

According to the invention, a low-irritant modified fiber fabric which ensures texture such as flexibility and drape properties, exhibits excellent water absorbing properties and hygroscopicity, exhibits excellent sweat absorbing properties, exhibits durability (anti-washing properties or the like), provides flexibility and elasticity to the skin, and exhibits a high skin regeneration support effect, and a method for producing the same can be provided. Therefore, the modified fiber fabric according to the invention may be suitably used for applications in which the modified fiber fabric directly and continuously contacts the skin, such as underwear, clothes, lining of clothes or the like, gloves, shoes, socks, sport clothes, sheet covers, towels, bath towels, morning shower towels, bedding (e.g. sheets, covers, or bedclothes), and medical materials (e.g. bandages, triangular bandages, and gauze).

### BRIEF DESCRIPTION OF THE DRAWINGS

FIG. 1 is a view showing an example of a chart of the height of the skin measured using a Cutometer.

### BEST MODE FOR CARRYING OUT THE INVENTION

The invention is described below in detail.

### <Modified Fiber Fabric>

A modified fiber fabric according to the invention is obtained by polymerizing a component (X) which is a water-soluble eggshell membrane powder, a component (A) which is a bifunctional monomer represented by the following formula (1), a component (B) which is a monomer containing any one of a hydroxyl group, carboxyl group, amino group, sulfonic acid group, and phosphoric acid group, and a component (C) which is a monomer containing at least one aziridine group, or a water-soluble polymer containing a polycarbodiimide group, polyethyleneimine group, or oxazoline group, on a fiber fabric,

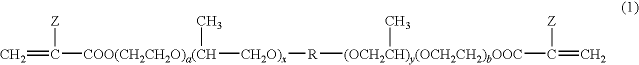

wherein R represents any one of

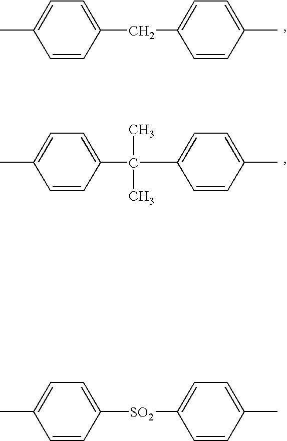

and —CₙH₂ₙ— (n is an integer of 1 to 6); Z is a hydrogen atom or a methyl group; a and b are integers where “a+b” is 0 to 50; x and y are integers where “x+y” is 0 to 30; and “a+b+x+y” is 10 or more.

The modified fiber fabric according to the invention has the function of supporting the cure capability and regeneration capability of the skin due to inclusion of the water-soluble eggshell membrane powder (X).

Human skin is made up of type I collagen (maintaining structure) and type III collagen (providing flexibility). The ratio of the type I collagen to the type III collagen changes with age. For example, embryo dermis has a ratio of the type I collagen to the type III collagen of 1:1. The proportion of the type III collagen decreases with age. Therefore, the ratio has a close relationship to skin ageing.

It was confirmed that the eggshell membrane has high affinity with a dermal fibroblast of an animal to cure the skin and increase the amount of type III collagen which provides the skin with flexibility (reported in the 64th Annual Scientific Meeting of The Japanese Biochemical Society, 1991).

Since the eggshell membrane is a water-insoluble protein, the eggshell membrane can be relatively easily collected and pulverized to particles by physical means.

Table 1 shows an example of the eggshell membrane powder and compositional analysis examples of other protein components (silk, sericin, and collagen).

TABLE 1

| | Eggshell | | | |
|---|---|---|---|---|
| | membrane | | | |
| Amino acid | (insoluble) | Silk | Sericin | Collagen |
| Lysine | 34 | 3 | 24 | 28 |
| Histidine | 39 | 2 | 5 | 5 |
| Arginine | 63 | 5 | 36 | 46 |
| Aspartic acid | 73 | 13 | 148 | 46 |
| Threonine | 51 | 9 | 87 | 17 |
| Serine | 50 | 121 | 373 | 37 |
| Glutamic acid | 105 | 10 | 34 | 70 |
| Proline | 73 | — | — | 129 |
| Glycine | 55 | 445 | 147 | 333 |
| Alanine | 25 | 293 | 43 | 112 |
| Cystine | 92 | 2 | 5 | — |
| Valine | 60 | 22 | 36 | 20 |
| Methionine | 38 | 1 | — | 6 |
| Isoleucine | 32 | — | — | 12 |
| Leucine | 48 | 5 | 14 | 23 |
| Tyrosine | 23 | 52 | 26 | 2 |
| Phenylalanine | 18 | 6 | 3 | 12 |
| Hydroxy-proline | — | — | — | 98 |
| Hydroxy-lysine | — | — | — | 6 |
| Tryptophan | 29 | 2 | — | — |

* The values in Table 1 indicate the proportion of the amino acid (number of residues per about 1000).

The eggshell membrane powder has a composition similar to that of collagen in comparison with other protein components in that the eggshell membrane powder contains a large amount of proline and arginine. This allows the eggshell membrane to exhibit high affinity with a dermal fibroblast of the living body, provide the skin with flexibility and elasticity, and exhibit a skin regeneration support effect.

In the invention, the water-insoluble eggshell membrane, which contains a large amount of specific amino acids contained in the type III collagen, which provides the skin with cure capability and regeneration capability and provides flexibility to the skin, at a high proportion, is used as a water-soluble eggshell membrane powder which efficiently contains the amino acids which are not destroyed.

The water-soluble eggshell membrane powder may be obtained as a water-soluble hydrolysate or a water-soluble substance containing a specific amount of an active thiol group by subjecting the eggshell membrane to a special chemical treatment, an enzyme treatment, or the like. In more detail, the water-soluble eggshell membrane powder may be obtained by causing a reduction reaction which cuts (cleaves) a crosslinked disulfide bond of a protein and a hydrolysis reaction which partially cuts a high-molecular-weight protein to occur either sequentially or simultaneously.

The “active thiol group” in the water-soluble eggshell membrane powder means a mercapto group (—SH) which produces a mercaptide derivative. The invention was achieved based on the finding that the mercapto group is suitable for a polymerization reaction. Specifically, the mercapto group readily reacts with double bonds contained in the bifunctional monomer (A) (represented by the formula (1)), the monomer (B) containing any one of a hydroxyl group, carboxyl group, amino group, sulfonic acid group, and phosphoric acid group, and the monomer (C) containing at least one aziridine group, or the water-soluble polymer (C) containing a polycarbodiimide group, polyethyleneimine group, or oxazoline group to significantly improve and promote the polymerization reaction.

A polymerization reaction using the water-soluble polymer containing an oxazoline group as a crosslinking agent is one of the preferred embodiments.

Since the water-soluble eggshell membrane powder or its aqueous solution contains a large amount of a mercapto group (—SH) which produces a mercaptide derivative, the water-soluble eggshell membrane powder or its aqueous solution emits a bad odor although it is suitable for a polymerization reaction. For example, the bad odor remains when merely immersing the fiber fabric in an eggshell membrane powder aqueous solution and drying the fiber fabric. This results in a fatal disadvantage. However, it has been found that the polymerization reaction of the invention removes the odor by causing the mercapto group (—SH) to be bonded and consumed, and that the removal of the odor may be utilized for the evaluation and evidence of completion of the polymerization reaction.

Note that that a water-insoluble eggshell membrane powder or its liquid dispersion emits an odor of a mercapto group to only a small extent. Other protein/amino-acid-containing powders (e.g. silk fibroin, sericin, or collagen) or their liquid dispersion also emit an odor of a mercapto group to only a small extent. Specifically, since such powders do not contain an effective amount of the mercapto group which takes part in the polymerization reaction, such powders are not suitable for the invention.

A configuration of the modified fiber fabric according to the invention is described below.

The modified fiber fabric according to the invention includes (i) a modified fiber fabric in which the component (X) and the components (A) to (C) are graft-polymerized to the fiber fabric, (ii) a modified fiber fabric in which one or more of the component (X) and the components (A) to (C) form a homopolymer and/or a copolymer on the fiber fabric, and (iii) a modified fiber fabric in which some of the components are graft-polymerized to the fiber fabric and the remaining components form a homopolymer and/or a copolymer on the fiber fabric.

Of these, the modified fiber fabric (i) in which the component (X) and the components (A) to (C) are graft-polymerized to the fiber fabric is preferable.

The constituent fiber of the fiber fabric used as the substrate is not particularly limited. As examples of the constituent fiber of the fiber fabric, natural fibers such as cotton, wool, silk, and hemp, synthetic fibers such as nylon, acrylic, polyester, polypropylene, polyethylene, and polytrimethylene terephthalate, mixed-spun fibers and composite fibers formed of two or more fibers selected from the above fibers, and the like can be given. The invention exerts a particularly significant effect on a fabric made of a polyamide fiber (e.g. nylon) or a polyester fiber or a mixed-spun fiber (e.g. polyester/cotton mixed-spun fiber) or a composite fiber containing such a fiber. Since such a fabric has high hydrophobicity, it is difficult to provide such a fabric with water absorbing properties and hygroscopicity using a known treatment. However, the invention can effectively provide such a fabric with water absorbing properties and hygroscopicity, provide the skin with flexibility and elasticity, and improve a skin regeneration support effect.

The form of the fiber fabric is not particularly limited. As examples of the form of the fiber fabric, woven fabric, knitted fabric, nonwoven fabric, and the like can be given. The fiber fabric may be treated by refining or dyeing, or subjected to anti-bacterial treatment, SR treatment, flame proof treatment, antistatic treatment, or the like. The fiber fabric may be used in a state in which the fiber fabric has been or has not been processed into a finished product such as clothes or underwear or a product such as gloves, socks, or bedding (e.g. sheets, covers, or bedclothes).

As the water-soluble eggshell membrane powder (X), a water-soluble eggshell membrane powder prepared by an alkali treatment method disclosed in JP-B-6-021047, an enzyme treatment method, a reducing agent treatment method, or the like may be used.

In the alkali treatment method, an eggshell membrane is treated in an aqueous solution (e.g. water or ethanol aqueous solution having an ethanol concentration of 40%) of an alkali metal hydroxide (e.g. sodium hydroxide or potassium hydroxide) at a concentration of about 1 to 30%. For example, when the amount of eggshell membrane is about 50 g, the eggshell membrane is treated in 1000 ml of a 1N alkali metal hydroxide aqueous solution.

In this case, alkali decomposition can be promoted by mixing and stirring the solution. The treatment temperature is about 40 to 80° C., and the treatment time is about 3 to 24 hours. The treated aqueous solution is filtered, and the filtrate is dialyzed against deionized water or the like to obtain a target protein/amino-acid-containing hydrolysate.

In the enzyme treatment method, an eggshell membrane is treated using a protease. As examples of the protease, proteases of plant origin, such as papain and bromelain, and proteases of animal origin, such as pancreatin, rennin, trypsin, chymotrypsin, and pepsine, can be given.

The treatment is performed in a liquid in which the raw material proteins are dispersed in water. The temperature and the pH during the treatment may be appropriately determined depending on the optimum temperature and the pH of the enzyme used. For example, when using pancreatin, the temperature is set at 35 to 50° C., and the pH is adjusted to about 6 to 8. The treated solution is filtered, and the filtrate is dialyzed against deionized water to obtain a target protein/amino-acid-containing hydrolysate.

In the reducing agent treatment method, an eggshell membrane is treated using a reducing agent. In this method, the disulfide bond in the raw material protein is reduced using a reducing agent such as sodium sulfide, thioglycolic acid, β-thiopropionic acid, alkali salt thereof, 2-mercaptoethanol, or the like. The amount of reducing agent is determined depending on the type of reducing agent. For example, when using β-thiopropionic acid, a 5N β-thiopropionic acid aqueous solution is used in an amount of about 2000 ml for 100 g of the eggshell membrane.

The treatment is performed in a liquid in which the raw material proteins are dispersed in water. When using β-thiopropionic acid as the reducing agent, the treatment temperature is about 60 to 80° C., and the treatment time is about five hours. The treated solution is filtered, and the filtrate is dialyzed against deionized water to obtain a target protein/amino-acid-containing water-soluble substance.

It is also possible to obtain a water-soluble substance of an eggshell membrane under milder conditions by using the reducing agent treatment method and the alkali treatment method in combination.

The resulting protein/amino-acid-containing water-soluble substance may be directly used as a component of a fiber treating liquid. Or, the water-soluble substance may be dehydrated to obtain a water-soluble eggshell membrane powder, and the water-soluble eggshell membrane powder may be dissolved in water before use.

The active thiol group content of the eggshell membrane powder may be determined by preparing an aqueous solution of a protein or an eggshell membrane powder determined in advance, and measuring the active thiol group content as an L-cysteine equivalent value (determination of —SH group) using a DTNB method (Ellman method). It is preferable that the active thiol group content be 1×10⁻⁴ to 1×10⁻³ mol for 1 g of the eggshell membrane powder. The average molecular weight of the water-soluble eggshell membrane powder is preferably 100 to 20,000.

In the invention, the component (X), which is expected to provide the skin with flexibility and elasticity and exert a skin regeneration support effect, is caused to adhere to the fiber fabric. In the invention, the component (X) exhibits excellent polymerization efficiency and affinity with the polymerization components or the graft polymerization components (components (A) to (C) described below), is caused to easily adhere to the fiber fabric regardless of the type of fiber fabric, and is not easily removed after being caused to adhere to the surface of the fiber fabric (exhibits durability).

The component (A) is not particularly limited insofar as the component (A) is the bifunctional monomer represented by the formula (1). In the formula (1), “a+b” is preferably 0 to 50, and particularly preferably 4 to 30.

“x+y” is preferably 0 to 30, and particularly preferably 4 to 30.

“a+b+x+y” is preferably 10 or more, still more preferably 10 to 40, and particularly preferably 10 to 30.

As specific examples of the component (A), compounds represented by the following formulas (2) to (5), and the like can be given.

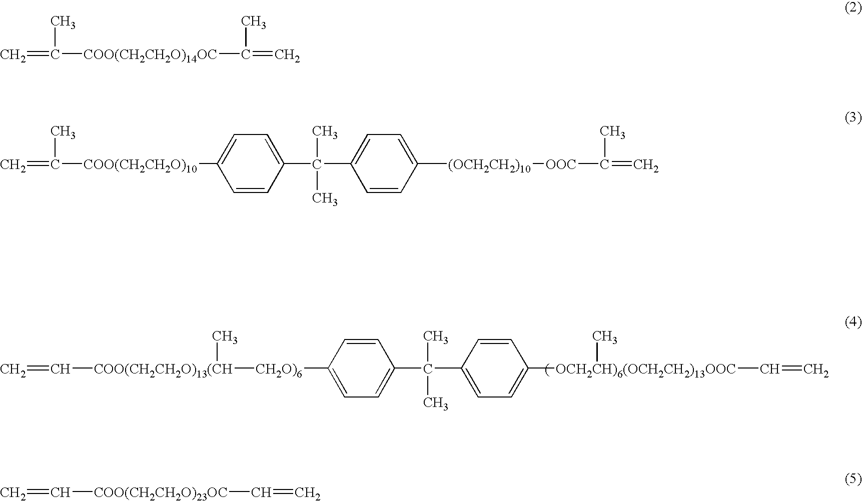

The component (B) is not particularly limited insofar as the component (B) is a monomer containing any one of a hydroxyl group, carboxyl group, amino group, sulfonic acid group, and phosphoric acid group. As specific examples of the component (B), acrylic acid, methacrylic acid, styrenesulfonic acid, maleic acid, itaconic acid, crotonic acid, vinylsulfone acid, 2-allyloxy-2-hydroxypropanesulfonic acid, 2-acrylamide-2-methylpropanesulfonic acid, 2-hydroxyethyl methacrylate, hydroxypropyl methacrylate, compounds represented by the following formulas (6) to (8), and the like can be given.

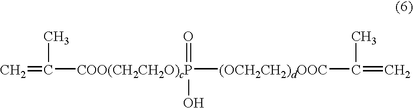

wherein c and d individually represent zero or a positive integer wherein “c+d” is 5 or more.

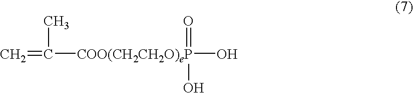

wherein e represents an integer of 5 or more.

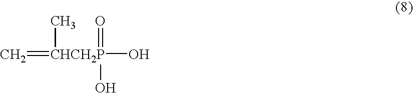

In the formula (6), “c+d” is preferably 2 to 40, and particularly preferably 4 to 30. In the formula (7), e preferably represents 2 to 40, and particularly preferably 4 to 30.

As the component (C), a monomer containing one aziridine group or a multifunctional monomer containing two or more aziridine groups may be used without specific limitations. As specific examples of the component (C), compounds represented by the following formulas (9) to (13), and the like can be given.

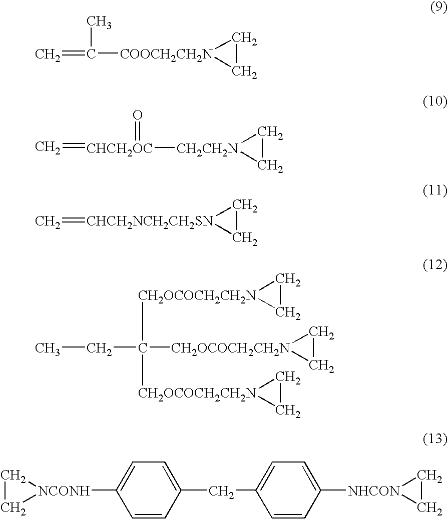

As the component (C), a water-soluble polymer containing a polycarbodiimide group, polyethyleneimine group, or oxazoline group may also be used without specific limitations.

Since the modified fiber fabric according to the invention includes the component (X), the modified fiber fabric exhibits the characteristics of the component (X). That is, the modified fiber fabric exhibits water absorbing properties and hygroscopicity, exhibits a skin regeneration support effect, and provides the skin with flexibility and elasticity.

The inventors of the invention have found that the polymerization reaction of the component (X) can be promoted by using the components (A) to (C) in combination with the component (X) so that the component (X) can be effectively introduced into the surface and inside of the fiber (leads to a significant increase in polymerization rate). A modified fiber fabric in which the component (X) is introduced into the surface and inside of the fiber does not show a starched state in comparison with a modified fiber fabric in which the component (X) adheres to only the surface of the fiber, exhibits remarkably excellent water absorbing properties and hygroscopicity while ensuring texture such as flexibility and drape properties, and exhibits remarkably excellent durability since the component (X) is not dissolved in water or removed in a short time during washing or the like. In particular, when the component (X) is graft-polymerized to the fiber fabric, since the component (X) is strongly bonded to the fiber fabric, further increased durability can be realized in addition to introducing the component (X) inside the fiber. Note that a modified fiber fabric in which the component (X) is introduced into the surface and inside of the fiber, or a modified fiber fabric in which the component (X) is graft-polymerized to the fiber fabric, has not yet been disclosed.

The components (A) to (C) used in combination with the component (X) are components exhibiting excellent water absorbing properties and hygroscopicity. Moreover, these components are easily diffused into the fiber and are polymerized. Therefore, the components (A) to (C) exhibiting excellent water absorbing properties and hygroscopicity can be introduced into the surface and inside of the fiber by polymerizing the components (A) to (C). Therefore, higher water absorbing properties and hygroscopicity can be obtained in comparison with the case of using only the component (X). Moreover, since the components (A) to (C) introduced to the inside of the fiber are not easily removed, the modified fiber fabric exhibits excellent durability. In particular, when these components are graft-polymerized to the fiber fabric, since the components are strongly bonded to the fiber fabric, further increased durability can be realized in addition to introducing the components to the inside of the fiber.

Therefore, the modified fiber fabric according to the invention obtained by polymerizing the component (X) and the components (A) to (C) on the fiber fabric is provided with a water absorption (hygroscopic) treatment on the surface and inside of the fiber. Accordingly, the modified fiber fabric exhibits extremely excellent water absorbing properties and hygroscopicity, provides the skin with flexibility and elasticity, and exhibits a skin regeneration support effect.

Since the modified fiber fabric according to the invention promptly absorbs sweat or the like during sports, the sweaty season such as summer, sleeping, or the like to allow the user to feel refreshed, the modified fiber fabric according to the invention is suitable for applications in which the modified fiber fabric directly contacts the skin, such as clothes, lining of clothes or the like, gloves, shoes, socks, underwear, hats, and footwear. The modified fiber fabric according to the invention may also be suitably used for applications such as sport clothes, sheet cover, towels, bath towels, morning shower towels, bedding (e.g. sheets, covers, or bedclothes), and medical materials (e.g. bandages, triangular bandages, and gauze). The modified fiber fabric according to the invention does not cause a user with hypersensitive skin to suffer from skin irritation and can provide the user with a skin regeneration support effect.

### <Method for Producing Modified Fiber Fabric>

A method for producing the above-described modified fiber fabric according to the invention is described below.

### (First Production Method)

A first production method according to the invention includes simultaneously polymerizing the component (X) and the components (A) to (C) on a fiber fabric. Specifically, the first production method according to the invention includes a liquid-contacting step of bringing a fiber treating liquid including the component (X) and the components (A) to (C) into contact with a fiber fabric, and a polymerization step of polymerizing the component (X) and the components (A) to (C) on the fiber fabric. The fiber treating liquid used in the first production method according to the invention has not yet been disclosed. The above-described modified fiber fabric according to the invention can be simply produced by using the fiber treating liquid.

The concentration of the component (X) in the fiber treating liquid is not particularly limited, and is appropriately set depending on the fiber fabric used and the like. The concentration of the component (X) is preferably about 0.1 to 30.0 mass %. If the concentration of the component (X) is less than 0.1 mass %, a long time may be required to secure (polymerize) the component (X) on the fiber fabric. If the concentration of the component (X) is more than 30.0 mass %, the viscosity of the fiber treating liquid may be increased, whereby the component (X) may be unevenly secured (polymerized) on the fiber fabric. Moreover, since unreacted compounds may remain, the fiber fabric may emit the odor of a mercapto group (—SH) which produces a mercaptide derivative, and the texture may be impaired.

The concentration of the component (A) in the fiber treating liquid is not particularly limited. The concentration of the component (A) is preferably about 1 to 20 mass %.

The concentration of the component (B) in the fiber treating liquid is not particularly limited. The concentration of the component (B) is preferably about 0.01 to 10 mass %.

The concentration of the component (C) in the fiber treating liquid is not particularly limited. The concentration of the component (C) is preferably about 0.01 to 5 mass %.

The ratio of the components (A), (B), and (C) is not particularly limited. It is preferable that “(A):(B):(C)” be “1:0.01 to 1:0.01 to 1”.

A solvent used in the fiber treating liquid is not particularly limited. As the solvent, water or an organic solvent (e.g. alcohol, dimethylformamide, acetone, or dimethylsulfoxide) may be used. The solvent may be used either individually or in combination of two or more. In particular, it is preferable to use an aqueous solvent as the solvent due to low skin irritation and a small effect on the living body. As the aqueous solvent, it is preferable to use water and/or an aliphatic lower alcohol with 1 to 3 carbon atoms. As examples of the aliphatic lower alcohol with 1 to 3 carbon atoms, methyl alcohol, ethyl alcohol, isopropyl alcohol, and the like can be given. These alcohols may be used either individually or in combination of two or more.

Various additives may be added to the fiber treating liquid in addition to the component (X) and the components (A) to (C). For example, the component (X) and the components (A) to (C) may be crosslinked during polymerization by adding a crosslinking agent such as a reactive resin such as a melamine resin, a glyoxal resin, or an epoxy resin, or an imine-type crosslinking agent.

A polymerization initiator such as potassium peroxide, ammonium persulfate, hydrogen peroxide, benzoyl peroxide, azobisisobutyronitrile, or t-butyl peroxide may also be added. A natural polymer containing amino acids useful for providing a higher moisturizing effect in an amount larger than that of the eggshell membrane powder, such as sericin, collagen, protein, or phospholipid monomer, may also be used together.

The fiber treating liquid may be prepared by adding the components (A) to (C) and arbitrary additives to an aqueous solution prepared by dissolving the component (X) in an aqueous solvent (e.g. water and/or aliphatic lower alcohol with 1 to 3 carbon atoms), for example.

The method of bringing the fiber treating liquid into contact with the fiber fabric is not particularly limited. As examples of the method, a dipping method, a padding method, and the like can be given. In the padding method, the fiber treating liquid is brought into contact with the fiber fabric, and the fiber fabric is optionally wrung to adjust the amount of the fiber treating liquid adhering to the fiber fabric. The fiber fabric is optionally dried by heating (drying heat treatment) at about 50 to 130° C. Note that the polymerization reaction does not sufficiently proceed by only the drying heat treatment.

After the above-described treatment, the components are polymerized. The component (X) and the components (A) to (C) may be polymerized by subjecting the fiber fabric to which the fiber treating liquid adheres to a wet-heat treatment, electron beam irradiation, ultraviolet irradiation, microwave irradiation, or the like.

When using the wet-heat treatment, the fiber fabric is treated in an atmosphere filled with steam at about 90 to 140° C. for 1 to 90 minutes, for example.

When using electron beam irradiation, ultraviolet irradiation, or microwave irradiation, the conditions such as the irradiation dose are arbitrarily adjusted depending on the fiber fabric and the fiber treating liquid used. In this case, electron beams, ultraviolet rays, or microwaves may be applied before or after the liquid-contacting step. When using electron beam irradiation, ultraviolet irradiation, or microwave irradiation, generated radicals are prevented from being lost by replacing the atmosphere during the polymerization reaction with nitrogen or the like, whereby the utilization rate of the polymerization components can be preferably increased.

In the invention, the polymerization reaction proceeds not only on the surface of the fiber but also inside the fiber. The production method according to the invention includes (i) a case where the component (X) and the components (A) to (C) are graft-polymerized to the fiber fabric, (ii) a case where the component (X) and the components (A) to (C) form a homopolymer and/or plural components thereof form a copolymer on the fiber fabric, and (iii) a case where some of the components are graft-polymerized to the fiber fabric and the remaining components form a homopolymer and/or a copolymer on the fiber fabric.

Of these, the case (i) where the component (X) and the components (A) to (C) are graft-polymerized to the fiber fabric is preferable.

After completion of the polymerization reaction, it is preferable to wash the fiber fabric in order to remove unreacted compounds adhering to the fiber fabric.

In the production method according to the invention, a known antimicrobial agent, SR agent, flame retardant, antistatic agent, or the like may be provided on the fiber fabric before the liquid-contacting step or after the polymerization step.

### (Second Production Method)

A second production method according to the invention includes polymerizing the components (A) to (C) on a fiber fabric, and then polymerizing the component (X). Specifically, the second production method according to the invention includes a first liquid-contacting step of bringing a fiber treating liquid including the components (A) to (C) into contact with a fiber fabric, a first polymerization step of polymerizing the components (A) to (C) on the fiber fabric, a second liquid-contacting step of bringing a solution of the component (X) into the fiber fabric on which the components (A) to (C) are polymerized, and a second polymerization step of polymerizing the component (X) on the fiber fabric.

As the fiber treating liquid including the components (A) to (C) and the solvent used for preparing the solution of the component (X), the fiber treating liquid and the solvent used in the above-described first production method according to the invention may be used.

The method for preparing the fiber treating liquid including the components (A) to (C), the method for bringing the fiber treating liquid into contact with the fiber fabric, and the method for polymerizing the components (A) to (C) are the same as those of the above-described first production method except that the component (X) is not used. The method for bringing the solution of the component (X) into contact with the fiber fabric and the method for polymerizing the component (X) on the fiber fabric are the same as the method for bringing the fiber treating liquid including the components (A) to (C) into contact with the fiber fabric and the method for polymerizing the components (A) to (C).

The first and second production methods according to the invention allow easy production of the above-described modified fiber fabric according to the invention which ensures texture, exhibits extremely excellent water absorbing properties and hygroscopicity, exhibits durability, does not cause a user with hypersensitive skin to suffer from skin irritation, provides flexibility and elasticity to the skin, and exhibits a high skin regeneration support effect.

The polymerization promoting effect for the component (X) is also obtained by the second production method which includes polymerizing the components (A) to (C) on the fiber fabric and then polymerizing the component (X), whereby the component (X) can be introduced into the surface and inside of the fiber. Note that the first production method which includes simultaneously polymerizing the component (X) and the components (A) to (C) on the fiber fabric exhibits a higher polymerization promoting effect for the component (X), whereby a modified fiber fabric exhibiting more excellent water absorbing properties, hygroscopicity, and durability can be obtained. Moreover, the first production method is preferable due to the decreased number of steps.

### EXAMPLES

Examples according to the invention and comparative examples are described below. In each example, fiber fabrics including a modified fiber fabric were produced, and the resulting fiber fabrics were evaluated on items including durability (before and after washing).

### (Evaluation Item and Evaluation Method)

Evaluation items and evaluation methods were as follows.

### (1) Confirmation of Amino Acid Adhesion

A sample was prepared and subjected to measurement as follows.

1. 200 to 600 cm² of a prepared fiber fabric was heated in 6N hydrochloric acid.

2. The solid was removed by filtration, and the filtrate was concentrated and dried.

3. The residue was eluted with a citric acid buffer solution (pH: 2.2) and filtered using a filter with a pore size of 0.45 μm.

4. An amino acid analysis sample vial was charged with the resulting product to conduct quantitative analysis of amino acids (instrument: HITACHI L-8500 Amino Acid Analyzer).

This quantitative analysis is hereinafter called “hydrochloric acid decomposition analysis”.

### (2) Flexibility and Elasticity of Skin and Skin Regeneration Support Effect

The items were evaluated using Cutometer MPA 580 (Integral Corporation) by measuring the height of the skin during and after suction.

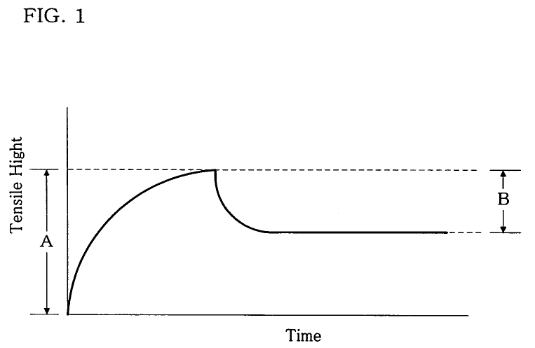

FIG. 1 shows an example of a chart of the height of the skin measured using the Cutometer.

The height A of the skin during suction (tensile height) is an index indicating the flexibility of the skin, and the ratio (B/A) of the height B of the skin after suction to the height A is an index indicating the elasticity (recovery rate) of the skin.

The skin regeneration support effect was evaluated according to the following procedure.

1. A commercially available adhesive tape was attached to the skin of the forearm of a subject, and then removed. The skin was then roughened using an acetone/ether solution.

2. The skin elasticity value and the skin surface properties of the test portion of the forearm of the subject were measured and confirmed (i.e. the state of the measurement portion before the test was confirmed).

3. A fabric sample (about 1×10 cm) was secured to the test portion of the subject, and was caused to be continuously in contact with the skin for about eight hours.

4. The step 3 was performed every day for 16 days.

5. After 16 days, the skin regeneration support effect was measured using the Cutometer and evaluated according to the following criteria.

Excellent: The flexibility (tensile height) of the skin was changed in an amount of 30% or more before and after the test, and the elasticity (recovery rate) of the skin was changed in an amount of 5% or more before and after the test.
Good: The flexibility (tensile height) of the skin was changed in an amount of 30% or more before and after the test, or the elasticity (recovery rate) of the skin was changed in an amount of 5% or more before and after the test.
Fair: The flexibility (tensile height) of the skin was changed in an amount of 10% or more before and after the test, and the elasticity (recovery rate) of the skin was changed in an amount of 3% or more before and after the test.
Inferior: The flexibility (tensile height) of the skin was changed in an amount of 10% or more before and after the test, or the elasticity (recovery rate) of the skin was changed in an amount of 3% or more before and after the test.
Bad: The flexibility (tensile height) of the skin was changed in an amount of less than 10% before and after the test, and the elasticity (recovery rate) of the skin was changed in an amount of less than 3% before and after the test.

This measurement is hereinafter called “skin flexibility evaluation”.

### (3) Hygroscopicity

The moisture absorption rate H was calculated using the following relational expression.

H={(H1−H0)/H0}×100(%)

In the above expression, H0 indicates the weight of the sample after being dried at 120° C. for three hours (absolute dry weight). H1 indicates the weight of the sample after being allowed to stand in a specific atmosphere for six hours or more after the above-mentioned drying procedure (moisture absorption weight).

The temperature and the humidity were respectively set at 30° C. and 90% RH corresponding to the atmosphere inside the clothes and at 20° C. and 65% RH corresponding to fresh air. Degree of hygroscopic sorption (ΔW): The degree of hygroscopic sorption is the difference between the amount of moisture absorption at 20° C. and 65% RH and the amount of moisture absorption at 30° C. and 90% RH, and is calculated using the following relational expression. The average value of the values obtained in five experiments was taken as the measured value.

ΔW=(weight increase rate when allowed to stand at 30° C. and 90% RH for 24 hours)−(weight increase rate when allowed to stand at 20° C. and 65% RH for 24 hours)

### (4) Water Absorbing Properties

The water absorbing properties were measured according to JIS L 1096 6-26-1 A (drop method).

### (5) Odor of Mercapto Group (—SH)

The presence or absence of an odor of a mercapto group (—SH) which produces a mercaptide derivative was evaluated by a sensory test by an odor judgment technician.

0: No odor
1: Slight odor
2: Weak odor which allows odor source to be recognized
3: Easily sensible odor
4: Strong odor
5: Severe odor

### (6) Durability

The amount of amino acids adhering was measured by the hydrochloric acid decomposition analysis and the flexibility and hygroscopicity of the skin were evaluated in the initial state (before washing) and after 20 times of washing to evaluate the durability.

The washing was carried out as follows according to the washing test described in JIS L-0217 103.

Water at 40° C. was placed in a tank of a test instrument until a water level indicating the standard water volume was reached. A washing synthetic detergent was added to and dissolved in the water in a standard amount to prepare a washing liquid. After the addition of the sample to the washing liquid so that the volume ratio was 1:30, the test instrument was operated. After treating the sample for five minutes, the test instrument was stopped. The sample was spin-dried using a spin drier. After replacing the washing liquid with fresh water at 30° C. or less, the sample was rinsed for two minutes at the same volume ratio. After rinsing the sample for two minutes, the test instrument was stopped. The sample was then spin-dried, again rinsed for two minutes, and spin-dried. The sample was hung or flat-dried in a state in which the sample was not directly subjected to sunlight. Then, the sample was optionally dry-ironed at a temperature appropriate for the material fiber.

### Example 1

Pongee woven fabric using a polyester false twist textured yarn having a weight of 110 g/m² was subjected to relaxation, scouring, presetting, alkali deweighting, and dyeing by known methods. The resulting fiber fabric was used as a substrate and modified.

A fiber treating liquid having a composition shown in Table 2 was prepared and applied to the fiber fabric by a padding method. The wet pickup rate was set at 60 wt %. The fiber fabric was then subjected to a wet-heat treatment at 110° C. and 98% RH for five minutes using steam to effect polymerization. After completion of the polymerization reaction, the fiber fabric was washed and finished. The resulting modified fiber fabric was evaluated.

TABLE 2

| | | Amount |
|---|---|---|
| | | (part |
| Component | | by mass) |
| Compo- | Water-soluble eggshell membrane powder | 10 |
| nent (X) | aqueous solution (solid content: 30%) | |
| | EM Powder-TF (manufactured by Idemitsu | |
| | Technofine Co., Ltd.) | |
| Compo- nent (A) | 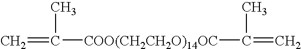 | 7 |
| Compo- | Methacrylic acid | 0.3 |
| nent (B) | | |
| Compo- nent (C) | 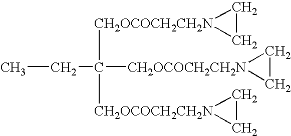 | 0.2 |
| Surfac- | ET135 (manufactured by Dai-Ichi Kogyo | 0.15 |
| tant | Seiyaku Co., Ltd.; nonionic/anionic | |
| | surfactant) | |
| Polymeri- | Ammonium persulfate | 0.3 |
| zation | | |
| initiator | | |
| Solvent | Water | 82.05 |

### Example 2

28-gauge interlock knitted fabric was prepared using polyester false twist textured yarn having a weight of 150 g/m². The resulting polyester knitted fabric was subjected to relaxation, scouring, presetting, and dyeing by known methods. The resulting fiber fabric was used as a substrate and modified.

The fiber treating liquid used in Example 1 was applied to the fiber fabric by a padding method. The wet pickup rate was set at 80 wt %. The fiber fabric was then dried at 120° C. for three minutes, and subjected to a wet-heat treatment at 105° C. and 97% RH for 60 minutes using steam to effect polymerization. After completion of the polymerization reaction, the fiber fabric was finished. The resulting modified fiber fabric was evaluated.

### Comparative Example 1

A modified fiber fabric was obtained in the same manner as in Example 1 except for preparing a fiber treating liquid having a composition shown in Table 3. The resulting modified fiber fabric was evaluated.

TABLE 3

| | | Amount |
|---|---|---|
| | | (part |
| Component | | by mass) |
| Compo- | Water-soluble eggshell membrane powder | 10 |
| nent (X) | aqueous solution (solid content: 30%) | |
| | EM Powder-TF (manufactured by Idemitsu | |
| | Technofine Co., Ltd.) | |
| Compo- nent (A) | 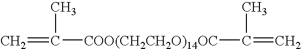 | 7 |
| Compo- | Methacrylic acid | 0.3 |
| nent (B) | | |
| Surfactant | ET135 (manufactured by Dai-Ichi Kogyo | 0.15 |
| | Seiyaku Co., Ltd.; nonionic/anionic | |
| | surfactant) | |
| Polymer- | Ammonium persulfate | 0.3 |
| ization | | |
| initiator | | |
| Solvent | Water | 82.65 |

### Comparative Example 2

A fiber fabric was obtained in the same manner as in Example 1 except for preparing a fiber treating liquid having a composition shown in Table 4. The resulting modified fiber fabric was evaluated.

TABLE 4

| | | Amount |
|---|---|---|
| | | (part by |
| Component | | mass) |
| Component (X) | Water-soluble eggshell membrane powder | 10 |
| | aqueous solution (solid content: 30%) | |
| | EM Powder-TF (manufactured by Idemitsu | |
| | Technofine Co., Ltd.) | |
| Surfactant | ET135 (manufactured by Dai-Ichi Kogyo | 0.15 |
| | Seiyaku Co., Ltd.; Nonionic/anionic) | |
| Polymerization | Ammonium persulfate | 0.3 |
| initiator | | |
| Solvent | Water | 89.55 |

### Comparative Example 3

A modified fiber fabric was obtained in the same manner as in Example 1 except for preparing a fiber treating liquid having a composition shown in Table 5. The resulting modified fiber fabric was evaluated.

TABLE 5

| | | Amount |
|---|---|---|
| | | (part by |
| Component | | mass) |
| Component (X) | Water-insoluble eggshell membrane | 10 |
| | powder liquid dispersion | |
| | (concentration: 30%) | |
| | EM Powder (300) (manufactured by Q.P. | |
| | Corporation) | |
| Surfactant | ET135 (manufactured by Dai-Ichi Kogyo | 0.15 |
| | Seiyaku Co., Ltd.; Nonionic/anionic) | |
| Polymerization | Ammonium persulfate | 0.3 |
| initiator | | |
| Solvent | Water | 89.55 |

Tables 6 and 7 show the amount of amino acids adhering, skin flexibility evaluation, test results for hygroscopicity and water absorbing properties, odor properties, and durability in each evaluation of the fiber fabrics obtained in Examples 1 and 2 and Comparative Examples 1, 2, and 3.

TABLE 6

| | Adhesion of amino acid (%) | | Skin flexibility evaluation | | Odor judgment | |
|---|---|---|---|---|---|---|
| | | After 20 times | | After 20 times | | After 20 times |
| | Initial state | of washing | Initial state | of washing | Initial state | of washing |
| Example 1 | 1.58 | 1.40 | Excellent | Good | 0 | 0 |
| Example 2 | 1.80 | 1.60 | Excellent | Good | 0 | 0 |
| Comparative | 1.50 | 0.70 | Good | Fair | 1 | 1 |
| Example 1 | | | | | | |
| Comparative | 0.20 | 0.05 | Bad | Bad | 4 | 3 |
| Example 2 | | | | | | |
| Comparative | 0.20 | 0.04 | Bad | Bad | 2 | 1 |
| Example 3 | | | | | | |

TABLE 7

| | 20° C. and 65% RH (%) | | 30° C. and 90% RH (%) | | Water absorbing properties (s) | |
|---|---|---|---|---|---|---|
| | | After 20 times | | After 20 times | | After 20 times |
| | Initial state | of washing | Initial state | of washing | Initial state | of washing |
| Example 1 | 1.0 | 0.8 | 3.0 | 2.5 | 2.0 | 4.0 |
| Example 2 | 1.6 | 1.3 | 4.0 | 3.4 | 0.2 | 0.5 |
| Comparative | 0.6 | 0.4 | 1.7 | 0.6 | 3.0 | 7.0 |
| Example 1 | | | | | | |
| Comparative | 0.4 | 0.3 | 0.5 | 0.3 | 120 | 180< |
| Example 2 | | | | | | |
| Comparative | 0.4 | 0.3 | 0.5 | 0.3 | 140 | 180< |
| Example 3 | | | | | | |

In Example 1, in which the fiber fabric was modified by polymerizing the component (X) and the components (A) to (C) on the fiber fabric, the initial amount of amino acids of the resulting modified fiber fabric was 1.58%, as shown in Tables 6 and 7. This indicates that the component (X) (amino acid) was introduced into the fiber fabric. A decrease in the amount of amino acids was small after 20 times of washing. Therefore, it was confirmed that the component (X) adhered to the fiber fabric in a state in which the component (X) was not easily removed. This is because the component (X) was introduced into the surface and inside of the fiber. The modified fiber fabric exhibited excellent texture such as flexibility and drape properties, and emitted no odor in the odor judgment.

The modified fiber fabric exhibited excellent skin flexibility and high hygroscopicity in the initial state and after 20 times of washing. The modified fiber fabric obtained in Example 1 showed no significant change in properties between the initial state and the state after 20 times of washing to exhibit excellent durability.

In the modified fiber fabric obtained in Example 2, the component (X) adhered to the fiber fabric in a state in which the component (X) was not easily removed in the same manner as in Example 1, and exhibited excellent texture. The modified fiber fabric exhibited excellent skin flexibility and high hygroscopicity in the initial state and after 20 times of washing, and exhibited excellent durability.

On the other hand, the modified fiber fabric obtained in Comparative Example 1, in which the water-soluble eggshell membrane powder was subjected to the hydrophilization treatment without using the crosslinking component (C), exhibited inferior skin flexibility and hygroscopicity in comparison with the modified fiber fabric obtained in Example 1.

In Comparative Examples 2 and 3 in which only the component (X) was polymerized on the fiber fabric, the amount of amino acids in the resulting fiber fabric was 0.2%, indicating that the component (X) was introduced into the fiber fabric. However, the amount of amino acids was significantly decreased after 20 times of washing. That is, most of the component (X) was removed during washing. This is because the component (X) was introduced into only the surface of the fiber and the component (X) was not polymerized. Moreover, since the component (X) was introduced into only the surface of the fiber, the fiber fabric exhibited significantly inferior initial hygroscopicity in comparison with Example 1. Although the fiber fabric exhibited hygroscopicity in the initial state, the hygroscopicity and water absorbing properties were decreased to a large extent after 20 times of washing due to removal of the component (X). As described above, the fiber fabrics obtained in Comparative Examples 2 and 3 exhibited insufficient durability. In Comparative Example 2, since the component (X) was not polymerized, the fiber fabric emitted a bad odor.

### Example 3

Nylon taffeta having a weight of 100 g/m² was subjected to scouring, presetting, and dyeing by known methods. The resulting fiber fabric was used as a substrate and modified.

A fiber treating liquid having a composition shown in Table 8 was prepared and applied to the fiber fabric by a padding method. The wet pickup rate was set at 50 mass %. The fiber fabric was then subjected to a wet-heat treatment at 105° C. and 98% RH for five minutes using steam to effect polymerization. After completion of the polymerization reaction, the fiber fabric was washed, dried, and finished. The resulting modified fiber fabric was evaluated.

TABLE 8

| | | Amount |
|---|---|---|
| | | (part |
| | | by |
| Component | | mass) |
| Component (X) | Water-soluble eggshell membrane powder aqueous solution (solid content: 30%) | 10 |
| | EM Powder-TF (manufactured by Idemitsu Technofine Co., Ltd.) | |
| Component (A) | 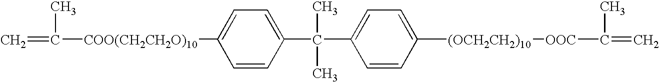 | 10 |
| Component (B) | Methacrylic acid | 0.5 |
| Component (C) | 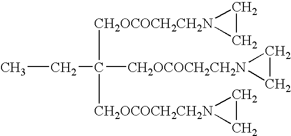 | 1.0 |
| Surfactant | ET135 (manufactured by Dai-Ichi Kogyo Seiyaku Co., | 0.15 |
| | Ltd.; nonionic/anionic surfactant) | |
| Polymerization | Ammonium persulfate | 1.0 |
| initiator | | |
| Solvent | Water | 77.35 |

### Comparative Example 4

Nylon taffeta used in Example 3 was subjected to scouring, presetting, dyeing, drying, and finishing by known methods to obtain a 100% nylon taffeta knitted fabric. The resulting fiber fabric was used as a substrate and modified.

A fiber treating liquid having a composition shown in Table 9 was prepared and applied to the fiber fabric by a padding method. The wet pickup rate was set at 50 mass %. The fiber fabric was then subjected to a wet-heat treatment at 105° C. and 98% RH for five minutes using steam to effect polymerization. After completion of the polymerization reaction, the fiber fabric was washed, dried, and finished. The resulting modified fiber fabric was evaluated.

TABLE 9

| | | Amount |
|---|---|---|
| | | (part |
| | | by |
| Component | | mass) |
| Component (X) | Silk fibroin powder liquid dispersion (solid content: 30%) | 10 |
| | EM Powder-TF (manufactured by Idemitsu Technofine Co., Ltd.) | |
| Component (A) | 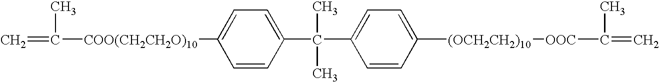 | 10 |
| Component (B) | Methacrylic acid | 0.5 |
| Component (C) | 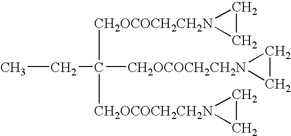 | 1.0 |
| Surfactant | ET135 (manufactured by Dai-Ichi Kogyo Seiyaku Co., | 0.15 |
| | Ltd.; nonionic/anionic surfactant) | |
| Polymerization | Ammoniun persulfate | 1.0 |
| initiator | | |
| Solvent | Water | 77.35 |

### Comparative Example 5

A modified fiber fabric was obtained in the same manner as in Example 3 except for preparing a fiber treating liquid having a composition shown in Table 10. The resulting modified fiber fabric was evaluated.

TABLE 10

| | | Amount |
|---|---|---|
| | | (part |
| | | by |
| Component | | mass) |
| Component (X) | Sericin powder liquid dispersion (solid content: 30%) | 10 |
| | (sericin: manufactured by Imai Orimono, Co., Ltd.) | |
| Component (A) | 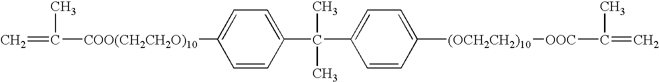 | 10 |
| Component (B) | Methacrylic acid | 0.5 |
| Component (C) | 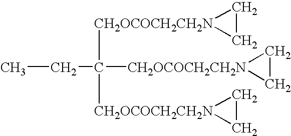 | 1.0 |
| Surfactant | ET135 (manufactured by Dai-Ichi Kogyo Seiyaku | 0.15 |
| | Co., Ltd.; nonionic/anionic surfactant) | |
| Polymerization | Ammonium persulfate | 1.0 |
| initiator | | |
| Solvent | Water | 77.35 |

### Comparative Example 6

A modified fiber fabric was obtained in the same manner as in Example 3 except for preparing a fiber treating liquid having a composition shown in Table 11. The resulting modified fiber fabric was evaluated.

TABLE 11

| | | Amount |
|---|---|---|
| | | (part |
| | | by |
| Component | | mass) |
| Component (X) | Atelocollagen aqueous solution (solid content: 30%) | 10 |
| | (collagen: manufactured by Kawaken Fine Chemicals Co., Ltd.) | |
| Component (A) | 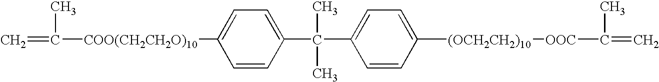 | 10 |
| Component (B) | Methacrylic acid | 0.5 |
| Component (C) | 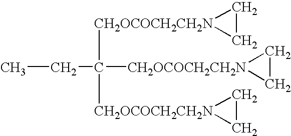 | 1.0 |
| Surfactant | ET135 (manufactured by Dai-Ichi Kogyo Seiyaku Co., | 0.15 |
| | Ltd.; nonionic/anionic surfactant) | |
| Polymerization | Ammonium persulfate | 1.0 |
| initiator | | |
| Solvent | Water | 77.35 |

Tables 12 and 13 show the amount of amino acids adhering, skin flexibility evaluation, test results for hygroscopicity and water absorbing properties, odor properties, and durability in each evaluation of the fiber fabrics obtained in Example 3 and Comparative Examples 4, 5, and 6.

TABLE 12

| | Adhesion of amino acid (%) | | Skin flexibility evaluation | | Odor judgment | |
|---|---|---|---|---|---|---|
| | | After 20 times | | After 20 times | | After 20 times |
| | Initial state | of washing | Initial state | of washing | Initial state | of washing |
| Example 3 | 1.56 | 1.44 | Excellent | Good | 0 | 0 |
| Comparative | 0.96 | 0.30 | Fair | Inferior | 0 | 0 |
| Example 4 | | | | | | |
| Comparative | 0.86 | 0.28 | Fair | Inferior | 0 | 0 |
| Example 5 | | | | | | |
| Comparative | 0.88 | 0.27 | Fair | Inferior | 0 | 0 |
| Example 6 | | | | | | |

TABLE 13

| | 20° C. and 5% RH (%) | | 30° C. and 90% RH (%) | | Water absorbing properties (s) | |
|---|---|---|---|---|---|---|
| | | After 20 times | | After 20 times | | After 20 times |
| | Initial state | of washing | Initial state | of washing | Initial state | of washing |
| Example 3 | 4.7 | 4.5 | 6.7 | 6.3 | 38 | 45 |
| Comparative | 4.3 | 4.1 | 5.0 | 4.4 | 62 | 92 |
| Example 4 | | | | | | |
| Comparative | 4.2 | 4.1 | 4.9 | 4.4 | 65 | 108 |
| Example 5 | | | | | | |
| Comparative | 4.2 | 4.1 | 4.9 | 4.3 | 70 | 110 |
| Example 6 | | | | | | |

In the modified fiber fabric obtained in Example 3, in which the fiber fabric was modified by polymerizing the component (X) and the components (A) to (C) on the fiber fabric, the component (X) adhered to the fiber fabric in a state in which the component (X) was not easily removed in the same manner as in Example 1, and exhibited excellent texture. The modified fiber fabric exhibited excellent skin flexibility and high hygroscopicity in the initial state and after 20 times of washing, and exhibited excellent durability.

On the other hand, the fiber fabric obtained in Comparative Example 4, in which silk fibroin was subjected to the hydrophilization treatment, exhibited similar hygroscopicity but exhibited inferior skin flexibility in comparison with the modified fiber fabric obtained in Example 3.

In the fiber fabric obtained in Comparative Example 5, in which sericin was subjected to the hydrophilization treatment, and in the fiber fabric obtained in Comparative Example 6, in which atelocollagen was subjected to the hydrophilization treatment, the component (X) was polymerized in the same manner as in Comparative Example 1. These fiber fabrics exhibited similar hygroscopicity but exhibited insufficient skin flexibility.

### INDUSTRIAL APPLICABILITY

According to the invention in which a specific polymerization reaction is employed, a low-irritant modified fiber fabric which ensures texture such as flexibility and drape properties, exhibits high water absorption properties and hygroscopicity, exhibits excellent sweat absorbing properties or the like, exhibits durability (anti-washing properties), provides flexibility and elasticity to the skin, and exhibits a high skin cure and regeneration promoting effect, and a method for producing the same can be provided.

Therefore, the modified fiber fabric according to the invention may be suitably used for applications in which the modified fiber fabric directly and continuously contacts the skin, such as underwear, clothes, lining of clothes or the like, gloves, shoes, socks, sport clothes, sheet covers, towels, bath towels, morning shower towels, bedding (e.g. sheets, covers, or bedclothes), and medical materials (e.g. bandages, triangular bandages, and gauze).

Note that the description in the specification does not limit the scope of the invention defined in the claims. Note also that modifications and alterations within the scope equivalent to the scope of the claims are also included within the scope of the invention.

1. A modified fiber fabric obtainable by polymerizing
a component (X) which is a water-soluble eggshell membrane powder,
a component (A) which is a bifunctional monomer represented by the following formula (1),
a component (B) which is a monomer containing any one of a hydroxyl group, carboxyl group, amino group, sulfonic acid group, and phosphoric acid group, and
a component (C) which is a monomer containing at least one aziridine group, or a water-soluble polymer containing a polycarbodiimide group, polyethyleneimine group, or oxazoline group, on a fiber fabric, 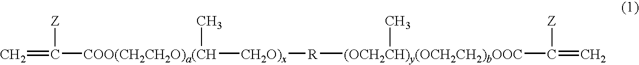
wherein R represents any one of 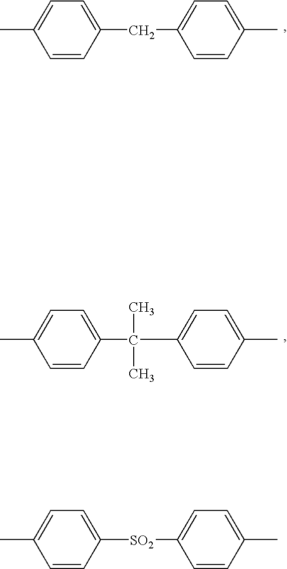
and —CₙH₂ₙn— (n is an integer of 1 to 6);
Z is a hydrogen atom or a methyl group;
a and b are integers where “a+b” is 0 to 50;
x and y are integers where “x+y” is 0 to 30; and
“a+b+x+y” is 10 or more.

2. The modified fiber fabric according to claim 1, wherein the component (X) and the components (A) to (C) are introduced into the surface and inside of the fiber.

3. The modified fiber fabric according to claim 1, wherein the component (X) and the components (A) to (C) are graft-polymerized to the fiber fabric.

4. A fiber treating liquid comprising:
a component (X) which is a water-soluble eggshell membrane powder,
a component (A) which is a bifunctional monomer represented by the following formula (1), a component (B) which is a monomer containing any one of a hydroxyl group, carboxyl group, amino group, sulfonic acid group and phosphoric acid group, and
a component (C) which is a monomer containing at least one aziridine group, or a water-soluble polymer containing a polycarbodiimide group, polyethyleneimine group, or oxazoline group, 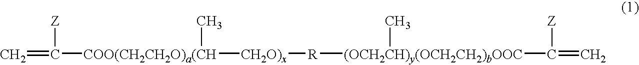
wherein R represents any one of 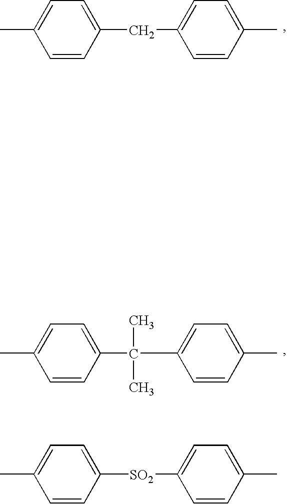
and —CₙH₂ₙ (n is an integer of 1 to 6);
Z is a hydrogen atom or a methyl group;
a and b are integers where “a+b” is 0 to 50;
x and y are integers where “x+y” is 0 to 30; and
“a+b+x+y” is 10 or more.

5. The fiber treating liquid according to claim 4, which contains at least one of water and an aliphatic lower alcohol with 1 to 3 carbon atoms as a solvent.

6. A method for producing a modified fiber fabric comprising the steps of:
bringing the fiber treating liquid of claim 4 into contact with a fiber fabric, and
polymerizing the component (X) and the components (A) to (C) on the fiber fabric.

7. The method according to claim 6, wherein the component (X) and the components (A) to (C) are graft-polymerized to the fiber fabric in the polymerization step.

8. A method for producing a modified fiber fabric, comprising:
a first liquid-contacting step of bringing a fiber treating liquid comprising a component (A) which is a bifunctional monomer represented by the following formula (1), a component (B) which is a monomer containing any one of a hydroxyl group, carboxyl group, amino group, sulfonic acid group, and phosphoric acid group, and a component (C) which is a monomer containing at least one aziridine group, or a water-soluble polymer containing a polycarbodiimide group, polyethyleneimine group, or oxazoline group, into contact with a fiber fabric,
a first polymerization step of polymerizing the components (A) to (C) on the fiber fabric,
a second liquid-contacting step of bringing a solution of a component (X) which is a water-soluble eggshell membrane powder into the fiber fabric on which the components (A) to (C) are polymerized, and
a second polymerization step of polymerizing the component (X) on the fiber fabric, 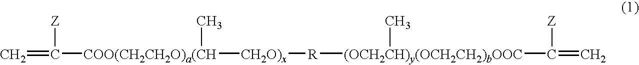
wherein R represents any one of 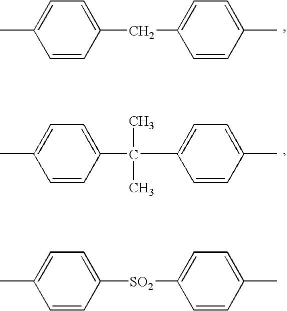
and —CₙH₂ₙ— (n is an integer of 1 to 6);
Z is a hydrogen atom or a methyl group;
a and b are integers where “a+b” is 0 to 50;
x and y are integers where “x+y” is 0 to 30; and
“a+b+x+y” is 10 or more.

9. The method according to claim 8, wherein the fiber treating agent and the solution of the component (X) comprise at least one of water and a lower aliphatic alcohol with 1 to 3 carbon atoms as a solvent.

10. The method according to claim 8, wherein the components (A) to (C) are graft-polymerized to the fiber fabric in the first polymerization step, and the component (X) is graft-polymerized to the fiber fabric in the second polymerization step.
